(19) United States
(12) Patent Application Publication
(10) Pub. No.: US 2007/0202284 A1
(43) Pub. Date: Aug. 30, 2007

(54) Cost-effective, sanitary, high-barrier microwavable wrapper

(75) Inventor: Christopher True, Bartlett, IL (US)

Correspondence Address: PEPSICO, INC.;c/o GOODWIN PROCTER LLP, 599 LEXINGTON AVE, NEW YORK, NY, 10022, US

(73) Assignee: The Quaker Oats Company, Chicago, IL (US)

(21) Appl. No.: 11/362,400

(22) Filed: Feb. 24, 2006

(51) Int. Cl. B32B 27/32

(52) U.S. Cl. 428/35.2; 428/35.7

(57) ABSTRACT

A package for a microwaveable food product has a pair of sidewalls each having an inner layer formed of a generally microwave transparent material, and an outer layer formed of a generally non-microwave transparent material having high oxygen barrier properties. A layer of adhesive is disposed between the two layers, bonding the layer together in a peelable bond. The inner layers are positioned adjacent to each other and sealed together adjacent to the peripheral edges of the sidewall to thereby seal a microwaveable food product therein. Prior to heating, the non-microwave transparent outer layer is peeled off the sidewalls of the package.

### FIELD OF THE INVENTION

The present invention relates to a multi-layer package, with a peelable outer layer, for packaging food products intended for microwave heating.

### BACKGROUND OF THE INVENTION

The last decade has seen a great increase in the popularity of the use of packaged foods that are microwaved by the consumer prior to eating. The list of such foods is extensive and continually expanding. Appetizers, entrees, desserts and snacks all are included in this trend with products ranging from popcorn to pizza. Typically, these food items are stored in their packages from the time of their production until the time that they are later heated or cooked in a microwave oven.

Some food products are relatively stable and their freshness easily maintained. Other food products present more of a challenge in maintaining their freshness, and thus require packaging having greater barrier properties. Depending upon their stability, microwavable food products have principally been packaged in one of three formats.

A first format utilizes a low-barrier, but microwavable wrapper, which is adequate for many types of less sensitive foods. While this option utilizes packaging material which is the least expensive, it does not have adequate barrier properties to store more sensitive food products without resulting in poor taste, poor texture, poor appearance, or even spoilage of the food stored.

A second more expensive packaging format is suitable for sensitive foods, and utilizes a high-barrier, but non-microwavable package. Food packaged using this format must be completely removed from its package prior to microwave heating. Thus, with this particular format the convenience of eating the heated food directly from the package is lost. Another drawback with use of this packaging format occurs when the food is to be heated in a microwave located in a public area, as may be the case for foods purchased at places such as a service station, convenience store or a fast food outlet. A consumer may be hesitant to completely remove the wrapper and then heat the bare food product in a public microwave of questionable or unknown cleanliness. Even when heating in a clean microwave oven, the exposed food product is prone to fouling the inside surfaces of the oven during heating or cooking, unless put into a separate closed container, that may or may not be available. Furthermore, many consumers prefer to eat a microwaved food product out of its original packaging, rather than heating in, and then eating from, a container that will later require cleaning.

A third, still more expensive packaging format employs the use of a packaging material that provides high-barrier properties, as well as being capable of microwaving. This packaging format has the drawback of being relatively expensive, and the increased cost of the wrapper can adversely impact the profit margin of a food manufacturer. If the increased cost of the wrapper is passed on to the consumer, the higher price for the packaged items may reduce sales volume.

Therefore, a need exists for a low cost microwaveable package which also has high-barrier properties.

### BRIEF SUMMARY OF THE INVENTION

In accordance of one aspect of the invention a package for a microwaveable food product is provided and has a first and second sidewalls . Each side wall is comprised of an inner layer formed of a generally microwave transparent material and an outer layer formed of a high oxygen barrier material. The inner layer has an inner surface and an outer surface with the inner surface of the inner layer of the first sidewall facing the inner surface of the inner layer of the second sidewall. The inner surfaces of the inner layers of the sidewalls are sealed adjacent the peripheral edges of the sidewalls to form a hollow interior for packaging a food product within the interior. The outer layer has an inner surface and a outer surface, the inner surface of the outer layer is positioned over the outer surface of the inner layer. An adhesive layer is positioned at least partially between the outer surface of the inner layer at the inner surface of the outer layer to peelably bond the outer layer to the inner layer. The bond is such that it allows manual removal of the outer layer. The microwaveable inner layer continues to package the food product during microwaving.

In another aspect of the invention a package for packaging a microwaveable food product is provided having a flexible inner wrapper formed of a first generally microwave transparent material and a flexible outer wrapper formed of a high oxygen barrier and generally non-microwave transparent second material. The outer wrapper substantially surrounds the inner wrapper. The outer wrapper is attached to at least a portion of the inner wrapper by an adhesive layer. The outer wrapper is readily manually removable from the inner wrapper to allow removal of a substantial portion of the outer wrapper. The food product in the inner wrapper may then be heated by microwaving.

In another aspect of the invention a multilayer packaging material is provided that has a first layer having a first surface and has a second layer having a second surface. An adhesive layer is disposed between the first surface and the second surface to at least partially bond the first layer to the second layer. The adhesive layer has a plurality of voids in the layer. The strength of the bond is such as to readily allow manual removal of the second layer from the first layer. The first layer is comprised of a substantially microwave transparent plastic material and the second layer is comprised of a high oxygen barrier substantially non-microwave transparent plastic material.

### BRIEF DESCRIPTION OF THE DRAWINGS

FIG. 1 is a cross sectional side view taken along line 1 of FIG. 6 showing the package in accordance with the invention with a food product packaged therein;

FIG. 2 is a cross sectional side view of the package of FIG. 1 showing the outer layer partially peeled away from the inner layer;

FIG. 3 is a cross sectional side view of the package of FIG. 1 showing the outer layer fully peeled off the package;

FIG. 4 is schematic drawing of the inner and outer layers and the adhesive layer there between;

FIG. 5 is a cross sectional side view of the multilayer packaging material of the package;

FIG. 6 is a perspective view of the package; and

FIG. 7 is a perspective view of the package with manual separation of the outer layer from the inner layer being initiated.

### DETAILED DESCRIPTION OF THE INVENTION

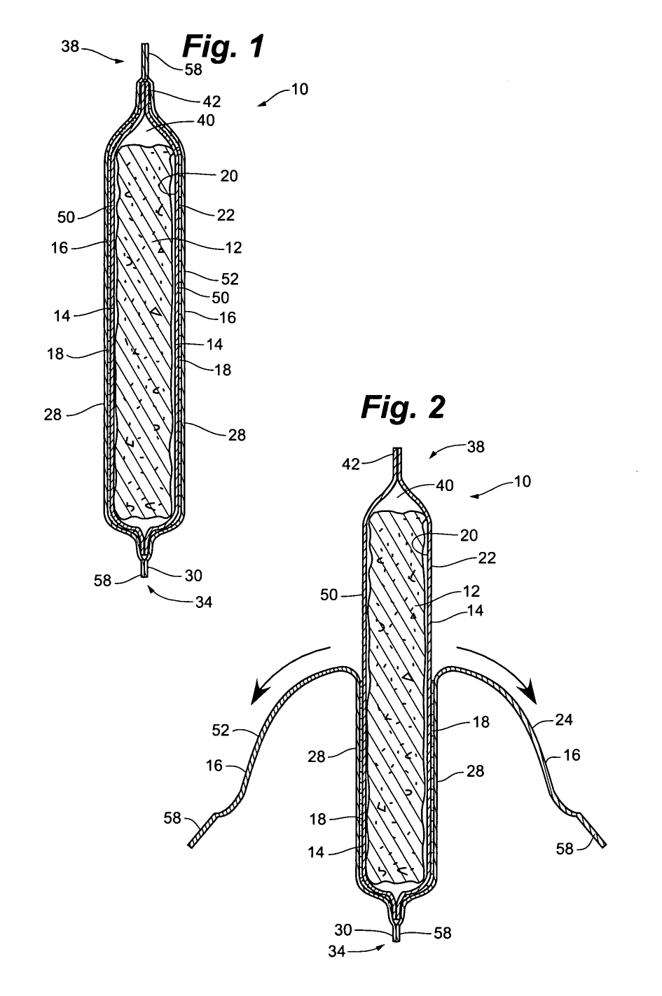

FIG. 1 illustrates a package 10 for a food product 12 which includes an inner layer 14 and a peelable outer layer 16 and an adhesive 18 there between. Inner layer 14 is formed of a microwave transparent material such as, for example, a clear and sealable polypropylene or polyester. Outer layer 16 is formed of a non-microwave transparent high oxygen barrier material such as metalized polypropylene or metalized polyester. Microwave transparent layer 14 has an inner surface 20 adjacent food product 12 and an outer surface 22. Adhesive 18 is applied to outer surface 22 of microwave transparent layer 14 and allows the inner surface 24 of outer barrier layer 16 to be peelably adhered to inner layer 14. Preferably, the adhesive layer 18 is applied by spraying, laminating, or otherwise depositing onto outer surface 22, a suitable adhesive material is, for example a peelable pressure-sensitive or other non-permanent laminating adhesive. Since it is desired that outer layer 16 be relatively easy to peel from inner layer 14, it is advantageous not to completely cover outer surface 22 with adhesive. Thus a waffle-shaped configuration as shown in FIG. 4, or other patterns that provide voids or adhesive free spaces 32 in adhesive layer 18, are preferred to facilitate manual separation of inner layer 14 and outer layer 16 at a later desired time. The voids may comprise at least one half of the area of adhesive layer 18, or the adhesive may be applied in only a relatively limited number of spots on outer surface 22 of inner layer 14.

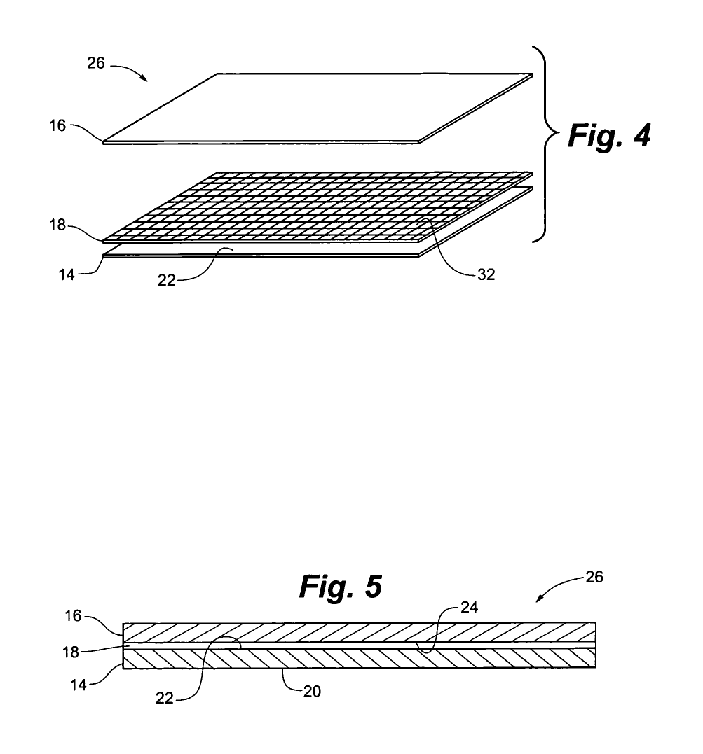

After application of adhesive 18 to inner layer 14, layers 14,16 are joined together, such as by pressing the outer barrier layer 16 against the outer surface 22 of layer 14 to form the multilayer packaging material 26 of the present invention as seen in FIG. 5. As an example, layer 14 and layer 16 each may be individually provided in the form of a roll of stock (not shown). A machine (not shown) is utilized to simultaneously unroll each layer, while at the same time spraying the pattern of adhesive layer 18 onto outer surface 22 of microwave transparent layer 14. The machine may then press layers 14, 16 together to form multilayer packaging material 26 that itself may be rolled up to provide a roll of stock of packaging material 26. The roll of multilayer packaging material 26 can then be utilized in forming multilayered package 10 of the present invention. In the alternative, adhesive layer 18 may be formed on the inner surface 24 of high oxygen barrier layer 16 rather than outer surface 22 of layer 14. It is also possible to spray adhesive onto both surfaces 22 and 24, however this generally may not be preferred since to do so would tend to increase the force required to later peel layer 16 from layer 14. It is also possible to form the adhesive layer as a distinct separate layer 18 which is positioned adjacent and then laminated onto the outer surface of layer 14.

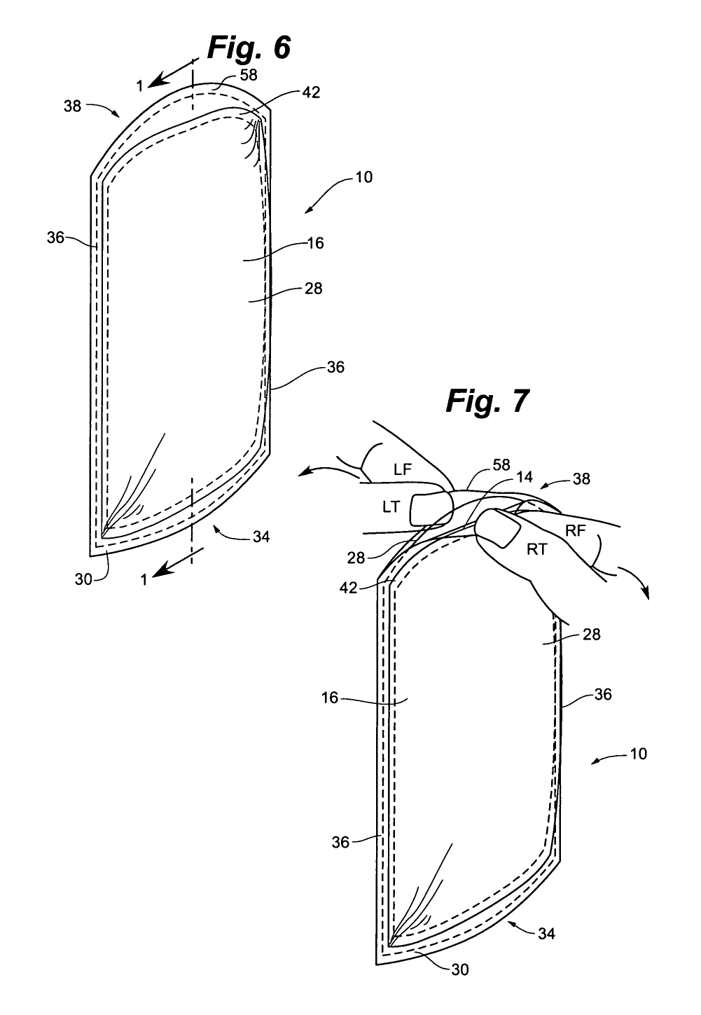

Referring to FIGS. 1 and 6, sheets of packaging material 26 of a desired shape and size, for example a generally rectangular shape, are used to form the sidewalls 28 of package 10. A pair of sidewalls 28 are arranged with inner surfaces 20 of inner layers 14 positioned face to face. The bottom ends 30 and the side edges 36 of the juxtaposed sidewalls 28 are sealed, such as by heat sealing, to form a package 10 that is closed at package bottom 34 and side edges 36. At this stage of assembly, package 10 has an top end 38 that is open providing access to the interior 40 of package 10. Food product 12 may then be inserted through top end 38 into interior 40 of package 10. Top edges 42 of top end 38 are then sealed, such as by heat sealing opposing inner surfaces 20 of inner layer 14 along top edges 42 to form a closed hermetically sealed package 10. To facilitate separation of outer layers 16 of sidewalls 28, sidewalls 28 may have one or more portions 58 where outer layer 16 extends beyond top end 42 of inner layer 14 to allow easier griping of the outer layers 16 for separation. Since the top ends of inner layer 14 seal food product 14 within package 10, if desired, outer layers 16 need not be sealed together at portions 58.

Other methods of packaging food product 12 will be readily apparent to those skilled in the art to meet the needs of various packaging applications. For example, food product 12 may be inserted between two sheets of multilayer packaging material 26 with the inner surfaces 20 of the inner layers 14 opposite each other. The bottom ends 30, side edges 36 and top edges 42 may then be heat sealed, or otherwise adhered together, to enclose food product 12 within a sealed package 10.

Package 10 may also be thought as two separate flexible wrappers 50,52 each forming, in effect, a separate package, as can be best appreciated in FIGS. 1-3. Inner wrapper 50 is formed of two sheets of inner layer 14 and outer wrapper 52 is formed of two sheets of outer layer 16. Alternatively, inner wrapper 50 and outer wrapper 52 may be formed separately and inner wrapper 50 inserted into outer wrapper 52. Food product 12 can then be inserted into inner wrapper 50 and thereafter top edges 42 of inner wrapper 50 can be sealed to enclose food product 12. Adhesive layer 18 between wrappers 50, 52 allows the outer wrapper 52 to be peelably attached to the inner wrapper 50.

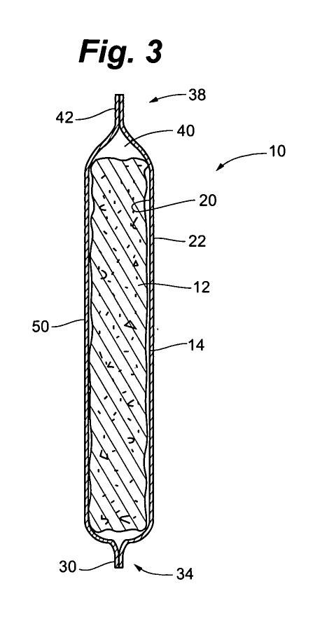

As seen in FIG. 7, when it is desired that food product 12 in package 10 be microwave heated, the consumer manually peels back the outer high barrier layer 16 beginning at portions 58 from the inner microwave transparent layer 14. To do so a user grips the outer layer 16 of one sidewall 28 at portion 58 with the users right thumb RT and right finger RF, and the other sidewall 28 at portion 58 in the users left thumb LT and left finger LF. Outer layers 16 of sidewalls 28 at portion 58 are then pulled apart. As seen in FIG. 2 outer layers 16 are continued to be peeled away from inner layers 14 along sidewalls 28. The peeling action is continued until outer layers 16 are entirely removed from package 10, leaving only inner layers 14 of inner wrapper 50. As seen in FIG. 3 inner wrapper 52 retains food product 12 for microwave heating. Inner wrapper 50 remains sealed, if desired, during microwaving.

After the food has been microwave heated, inner wrapper 50 consisting of inner layer 12 can be opened along top edges 42 and used for a container from which food product 12 is consumed. Or if desired, food product 12 may be removed from inner layers 14 and placed on another surface for serving.

Thus, a higher barrier microwaveable multilayer food package 10 is provided that is capable of preserving relatively sensitive food products requiring barrier properties not available with lower cost microwaveable packaging materials. Moreover utilization of a high cost single material that is both a high oxygen barrier and microwaveable is avoided. Instead, the package of the present invention accomplishes its objective at a lower cost, providing high barrier properties and allowing microwaving through use of peelable high oxygen barrier outer layer 14 and microwaveable inner layer 12.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

Modifications may be made to the embodiments described above without departing from the broad inventive concepts thereof. Accordingly, the present invention is not limited to the particular embodiments nor to the theoretical description disclosed, but is intended to cover all modifications that are within the spirit and scope of the invention as defined in the appended claims.

What is claimed is:

1. A package for a microwaveable food product comprising:
a first sidewall and a second sidewall, each of said sidewalls having peripheral edges, said sidewalls comprised of an inner layer formed of a generally microwave transparent material and an outer layer formed of a high oxygen barrier material, said inner layer having an inner surface and an outer surface, said inner surface of said inner layer of said first sidewall facing said inner surface of said inner layer of said second sidewall, said inner surfaces of said inner layers of said sidewalls being sealed together adjacent said peripheral edges, to form a hollow interior for packaging a food product within said interior,
said outer layer having an inner surface and an outer surface, said inner surface of said outer layer positioned over said outer surface of said inner layer,
an adhesive layer positioned at least partially between said outer surface of said inner layer and said inner surface of said outer layer to peelably bond said outer layer to said inner layer to allow manual removal of said outer layer from said inner layer so that said generally microwave transparent inner layer may continue to package said food product for microwave heating of said food product.

2. The package of claim 1 wherein said microwaveable inner layer is formed of a material comprising polypropylene or polyester.

3. The package of claim 1 wherein said high oxygen barrier outer layer is formed of a material comprising metalized polypropylene or metalized polyester.

4. The package of claim 1 wherein said microwaveable inner layer is formed of a material comprising polypropylene or polyester, and said high oxygen barrier outer layer is formed of a material comprising metalized polypropylene or metalized polyester.

5. The package of claim 4 wherein said adhesive layer is formed of a waffle-shaped pattern.

6. The package of claim 5 wherein said inner surfaces of said inner layers of said sidewalls are sealed together adjacent said peripheral edges by heat sealing.

7. A package for packaging a microwaveable food product comprising:
a flexible inner wrapper formed of a first generally microwave transparent material, said wrapper having an inner surface for surrounding a food product packaged therein, and an outer surface,
a flexible outer wrapper formed of high oxygen barrier, generally non-microwave transparent second material, said outer wrapper having an inner surface, said inner surface of said outer wrapper positioned adjacent to said outer surface of said inner wrapper, said outer wrapper substantially surrounding said inner wrapper,
an adhesive layer formed on one of said outer surface of said inner wrapper and said inner surface of said outer wrapper, said adhesive layer adhering said outer wrapper to said inner wrapper and allowing said outer wrapper to be readily manually peelable from said inner wrapper so that a food product packaged within said inner wrapper may be heated by microwaving.

8. The package of claim 7 wherein said inner wrapper is comprised of at least one layer of material selected from the group comprised of polypropylene and polyester.

9. The package of claim 7 wherein said high barrier outer wrapper is comprised of at least one layer of material selected from the group consisting of metalized polypropylene or metalized polyester.

10. The package of claim 7 wherein said microwaveable inner wrapper is formed of a material comprising polypropylene or polyester, and said high oxygen barrier outer wrapper is formed of a material comprising metalized polypropylene or metalized polyester.

11. The package of claim 10 wherein said adhesive layer has a plurality of voids in said adhesive layer to facilitate separation of said outer wrapper from said inner wrapper, said voids occupying at least 50% of the area of said adhesive layer.

12. The package of claim 11 wherein said adhesive material is in the form of a layer of a waffle-shaped pattern and said waffle shaped layer is laminated on said outer surface of said inner wrapper.

13. A multilayer packaging material comprising a first layer having a first surface, and a second layer having a second surface and an adhesive layer between said first surface and said second surface to bond said first layer to said second layer, said adhesive layer having a plurality of voids in said adhesive layer, the strength of said bond being such as to readily allow manual removal of said second layer from said first layer, said first layer comprised of a substantially microwave transparent plastic material, and said second layer comprised of a high oxygen barrier, substantially non-microwave transparent plastic material.

14. The packaging material of claim 13 wherein said microwaveable first layer is formed of a material comprising polypropylene or polyester.

15. The packaging material of claim 13 wherein said high oxygen barrier second layer is formed of a material comprising metalized polypropylene or metalized polyester.

16. The packaging material of claim 13 wherein said substantially microwave transparent inner layer is formed of a material comprising polypropylene or polyester, and said high oxygen barrier outer layer is formed of a material comprising metalized polypropylene or metalized polyester.

17. The packaging material of claim 16 wherein said adhesive layer is comprised of a layer of adhesive formed in a waffle-shaped pattern.

18. The packaging material of claim 16 wherein said voids comprise at least 50% of said adhesive layer.
